(19) United States
(12) Patent Application Publication
(10) Pub. No.: US 2008/0001934 A1
(43) Pub. Date: Jan. 3, 2008

(54) Apparatus and method for self-refresh in a display device

(76) Inventor: David Anthony Wyatt, San Jose, CA (US)

Correspondence Address: INTEL CORPORATION;c/o INTELLEVATE, LLC, P.O. BOX 52050, MINNEAPOLIS, MN, 55402, US

(21) Appl. No.: 11/478,512

(22) Filed: Jun. 28, 2006

(51) Int. Cl. G09G 5/00

(52) U.S. Cl. 345/204

(57) ABSTRACT

A method and apparatus for self-refresh in a display device is described. In an embodiment, a system display has a display screen that includes a pixel value storage component. The system display is coupled with a graphics control module via a display bus and enables a self-refresh mode based on a first indication from the graphics control module. The self-refresh mode includes refreshing pixel values stored within the pixel value storage component. The self-refresh rate is not greater than, a refresh rate provided by the graphics control module.

### FIELD

Embodiments of the invention relate generally to display technology. More specifically, the invention involves reducing power consumed in mobile computer systems by minimizing power associated with refreshing the display.

### BACKGROUND

Various display technologies exist that create an appearance that images on a screen are in motion. The basic technique involves displaying a succession of frames, each frame including a slightly different image. For static images, a frame of the same image is displayed over and over again.

In modern image display technology (e.g. cathode ray tube (CRT) television, plasma, liquid crystal diode (LCD)), each frame is made up of a collection of picture elements called pixels. Mobile computer system displays typically have panels with pixel resolutions in the range of 800×600 to 1900×1200 pixels per horizontal and vertical line. The intensity and color of each pixel can be adjusted so that together, the pixels compose a recognizable image. In typical mobile computer color displays, the color that each pixel describes may be composed of red (R), green (G), and blue (B), and possibly also including white (W).

Drawing a frame involves producing the proper light and color intensities at each pixel position. In most display technologies, as soon as a frame is drawn to a screen, the levels of intensity at each pixel begin to decay, which degrades the image. The rate at which a frame must be re-drawn to maintain the desired appearance of an image is called the refresh rate. Between frames that contain different images, there are typically multiple refreshes of each image. Thus, the refresh rate must typically be greater than the frame rate.

Mobile devices that use display technology rely on battery power to power their displays. Each time a display is refreshed, power is consumed across many components of the system and a mobile device's limited reserve of battery life is reduced. Mobile devices using modern display technology are commonly designed with a refresh rate that attempts to balance image quality with reduced power consumption. Unfortunately, refresh rates often are higher than necessary to achieve desired image quality.

Since minimizing power consumption is a key design goal for mobile devices, there is need to reduce refresh rates in mobile device displays while still providing the display images of a desired quality.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a block diagram of an embodiment of a display system;

FIG. 2 illustrates a block diagram of an embodiment of a display device;

FIG. 3 is a flow diagram of an embodiment of a process of operating a display device in different refresh modes;

FIG. 4 illustrates a block diagram of an embodiment of a graphics control module;

FIG. 5 s a flow diagram of an embodiment of a process for causing a display device to enter a self-refresh mode;

FIG. 6 illustrates a block diagram of an embodiment of a mobile device;

FIG. 7a is a block diagram illustrating an embodiment of an LCD display device configured to be refreshed by a graphics controller;

FIG. 7b is a block diagram illustrating an embodiment of LCD display panel electronics;

FIG. 8 is a circuit diagram illustrating an embodiment of thin film transistor electronics that hold a charge and a graph illustrating an example discharge rate;

FIG. 9 is a block diagram illustrating an embodiment of a self-refreshing LCD display device;

FIG. 10 is a block diagram illustrating an embodiment of a self-refreshing LCD display device;

FIG. 11 is a state diagram illustrating an embodiment of a self-refresh display state machine

FIG. 12 is a algorithm of an embodiment of a process for self-refresh.

### DETAILED DESCRIPTION

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in an embodiment may be included within other embodiments. The following detailed description is, therefore, not to be taken in a limiting sense, and the scope of the present invention is defined only by the appended claims, along with the full scope of equivalents to which such claims are entitled.

In general, a method and apparatus for self-refreshing in a display device are disclosed. In the following description, for purposes of explanation, numerous specific details are set forth in order to provide a thorough understanding of the present invention. It will be apparent, however, to one skilled in the art that the present invention can be practiced without these specific details.

Described herein are embodiments of a system display with a display screen that includes a pixel value storage component. The system display can be coupled with a graphics control module over a display bus. The system display enables a self-refresh mode based on a first indication from the graphics control module. Self-refresh mode includes refreshing pixel values stored within the pixel value storage component. The self-refresh rate is not greater than a first refresh rate provided by the graphics control module.

Also described herein are embodiments of a graphics control module that has a first output terminal to couple with a memory over a memory bus and a second output terminal to couple with a system display over a display bus. The graphics control module is configured to control refresh of the system display and has a frame rate monitor to track an effective frame rate value of the system display. When the threshold effective frame rate value has been detected, the graphics control module stops controlling the refresh and transmits one or more signals to the system display with a self-refresh signaler to trigger the system display to enter a self-refresh mode.

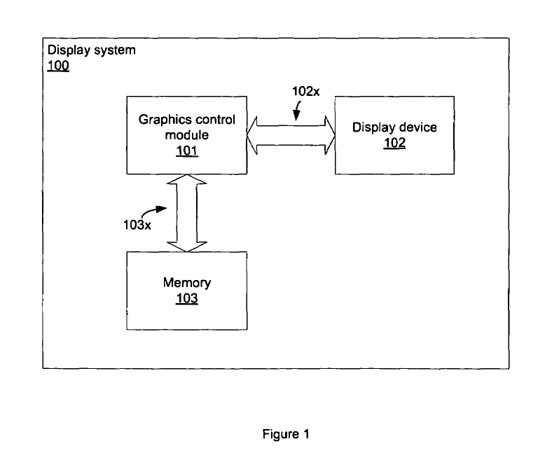

FIG. 1 is a block diagram of an embodiment of a display system 100. Display system 100 includes graphics control module 101 communicatively coupled with display device 102 via a display bus 102x and communicatively coupled with memory 103 via a memory bus 103x. Graphics control module 101 controls the transfer of content to display device 102. Display device 102 displays content transferred from memory 103.

Graphics control module 101 may process logic to operate a state machine (e.g. with an integrated circuit) to control various operations related to display device 102 (e.g. applying a refresh rate) and/or access memory 103. Graphic control module 101 may also process logic that generates signals (e.g. commands) and transmits signals over display bus 102x and memory 103x bus.

Memory 103 is any storage medium known by one having ordinary skill in the art with the ability to store digital information that can be accessed by graphic control module 101 during performance of the functions of the graphic control module 101 described herein. Memory may be for example random access memory (RAM).

Display device 102 may is a screen that illustrates images to be viewed by users of display system 100 (e.g. a computer system monitor). Display device 102 may utilize various hardware and software known in the art to display static and dynamic images. As such, display device may need to be refreshed periodically in order to provide the desired display output.

Thus, graphics control module 101 retrieves information located within memory 103 over memory bus 103x and sends the information to display device 102 over display bus 102x. The information may be related to a frame containing an image. Display device 102 may then use the information to display the frame containing the image.

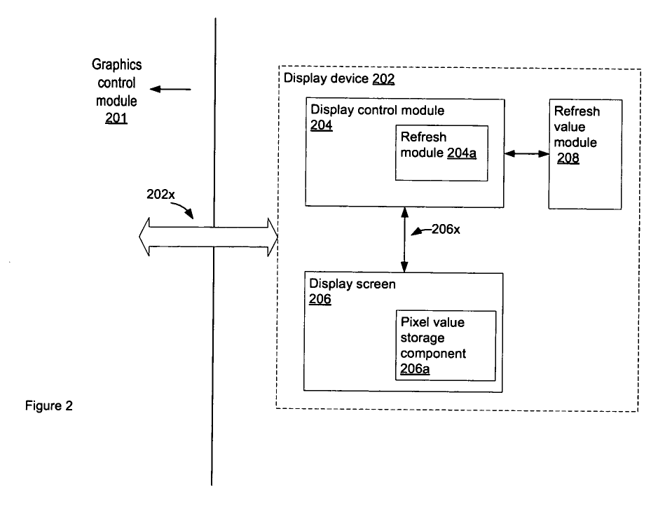

FIG. 2 is a block diagram illustrating an embodiment of a display device 202. Display device 202 includes display control module 204 coupled to display screen 206. Display control module implements logic (e.g. with circuitry or software) designed to control the operation of display screen 206 (e.g. a timing controller (TCON)). Display control module 204 may be in communication with graphics control module 201 via display bus 202x to receive image information and control signals (e.g. commands) related to control of display screen 206.

Display screen 206 may be the actual housing and surface of the screen as well as the material displaying individual pixels (e.g. housing, glass screen and phosphor coat, etc. on CRT display or the LCD's housing, polarized planes, liquid crystals, glass, electrode planes, color filters, etc). Display screen 206 includes pixel value storage component 206a. Pixel value storage component 206a may be a memory or memories that store(s) digital values (e.g. pixel values) that correspond to light and color intensities to be projected at each pixel. Pixel value storage component 206a stores pixel values representing what is currently being displayed on display screen 206. Pixel value storage component 206a may also store past or future pixel values.

Thus, an embodiment of an apparatus is disclosed that includes a display device 202 having a display screen 206 that includes a pixel value storage component 206a. The display device 202 is coupled with a graphics control module 201 via a display bus 202x and is configured to enable a self-refresh mode based on a first indication from the graphics control module 202. Self-refresh mode includes refreshing pixel values stored within the pixel value storage component 206a, and where the self-refresh rate is not greater than a first refresh rate provided by the graphics control module 201.

In an embodiment, display device 202 includes a display control module 204 that reads pixel values from the pixel value storage component 206a and refreshes them before writing the refreshed pixel values back into the pixel value storage component 206a.

Display device 202 includes refresh module 204a that is configured to encode and/or decode messages (e.g. low voltage differential signaling (LVDS)) sent between graphics control module 201 and display control module 202 via display bus 202a. One example of refresh module 204a is a hardwired circuit implementation of an encoder/decoder state machine.

Thus, in an embodiment, refresh module 204a receives a first indication from graphics control module 201 and triggers the display device 202 to enter self-refresh mode based on the first indication. Conversely, refresh module 204a triggers the self-refresh mode to be disabled based on the receipt of a second indication from the graphic control module 201.

Display device 202 may also include a refresh value module 208 coupled with display controller 204. The refresh value module 208 contains pixel values that are to replace the pixel values that are being refreshed. In other words, each pixel value stored in refresh value module 208 corresponds to one of the pixels from pixel value storage component 206a being refreshed. In an embodiment, pixel value storage component 206a is a read only memory (ROM) to store the pixel values.

Thus, in an embodiment, the refresh value module 208 stores new pixel values that correspond to old pixel values read from within the pixel value storage component 206a. In this embodiment, display control module 204 refreshes the old pixel values by exchanging the old pixel values with corresponding new pixel values that it retrieves from the refresh value module 208.

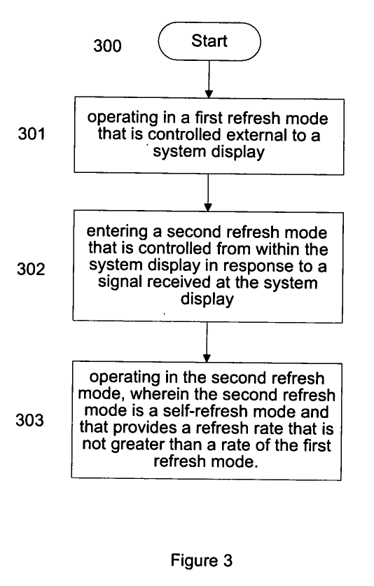

FIG. 3 is a flow diagram of an embodiment of a process 300 for entering a system into to a self-refresh mode. In FIG. 3, process 300 starts with processing logic operating in a first refresh mode that is controlled external to a system display (processing block 301)

The sequence continues when processing logic causes the system to enter a second refresh mode that is controlled from within the system display in response to a signal received at the system display (processing block 302).

Process 300 concludes when processing logic causes operation in the second refresh mode, wherein the second refresh mode is a self-refresh mode and that provides refresh rates that are not greater than a rate of the first refresh mode.

Through the practice of embodiments described herein, reduced power consumption by a computer system including display device may be realized by using a self-refresh rate that temporarily removes power consumption involved with refresh operations performed by a graphics control module or dependant memory sub-systems.

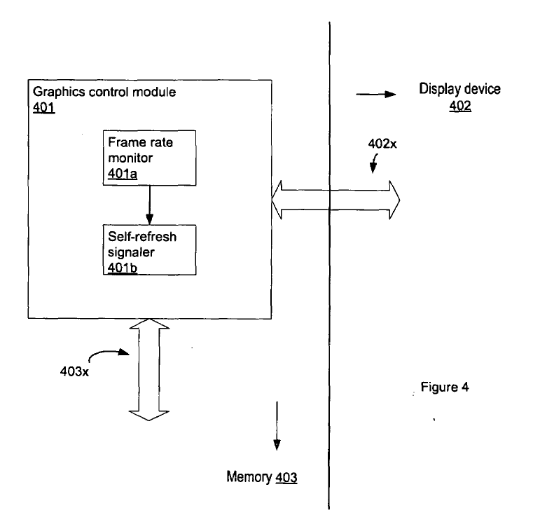

FIG. 4 is a block diagram of an embodiment of a graphics control module 401 coupled between a memory 403 and a display device 402. Graphic control module 401 includes frame rate monitor 401a and self-refresh signaler 401b.

Frame rate monitor 401a is logic to detect the effective frame rate per second (EFPS) being delivered to display device 402. Frame rate monitor 401a may use information indicating rendering or updating activity in memory 403 to arrive at current EFPS. Alternatively, if graphics control module 401 was for example to send ten different frames to display device 402 to be displayed one after another over one second, then frame rate monitor may detect a frame rate of 10 frames per second (FPS). Frame rate monitor 401a may compare the frame rate it detects with a frame rate threshold to determine whether conditions warrant display device 402 self-refresh.

Self-refresh signaler 401b is configured to receive signals from frame rate monitor 401a. Self-refresh signaler 401b is configured to encode and/or decode messages (e.g. LVDS) sent between graphics control module 401 and display control module 402 via display bus 402x. One example of self-refresh signaler 404b is a hardwired circuit implementation of an encoder/decoder state machine.

Thus, in an embodiment, a graphics control module 401 has a first output terminal to couple with memory 403 via memory bus 403x and a second output terminal to couple to display device 402 via display bus 402x. During some operations, graphics control module 401 controls refresh of the display device 402. Graphics control module 401 also includes a frame rate monitor 401a to track an effective frame rate of the display device 402 and to cause the graphics control module 401 to stop controlling the refresh when a threshold frame rate value has been detected. The self-refresh signaler 401b transmits a signal to the display device 402 upon detection of the threshold effective frame rate value to trigger the display device 402 to enter a self-refresh mode.

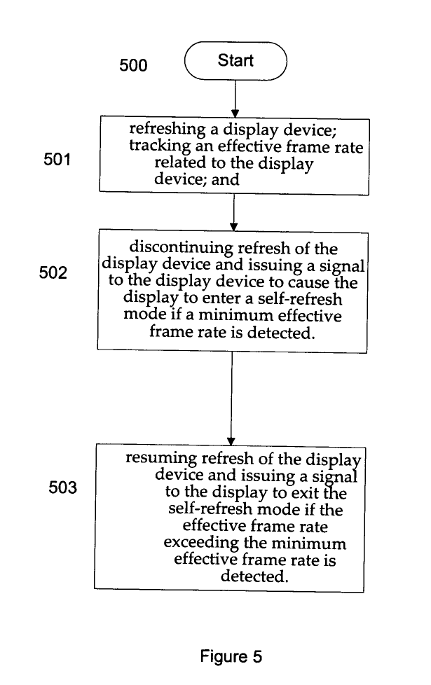

FIG. 5 is a flow diagram of an embodiment of a process 500 for bringing a display device in and out of a self-refresh mode.

Process 500 begins with processing logic refreshing a display device (processing block 501). The process continues with processing logic tracking an effective frame rate related to the display device (processing block 502). The process concludes with processing logic discontinuing refresh of the display device and issuing a signal to the display device to cause the display to enter a self-refresh mode if a minimum effective frame rate is detected (processing block 503).

In an embodiment process 500 may continue with processing logic resuming refresh of the display device and issuing a signal to the display to exit the self-refresh mode if the effective frame rate exceeding the minimum effective frame rate is detected (processing block 504).

Through the practice of embodiments described herein, reduced power consumption by a computer system including display device may be realized by using a self-refresh rate that temporarily removes power consumption involved with refresh operations performed by a graphics control module or dependent memory subsystems.

Other embodiments of the present invention can be accomplished by way of software. For example, in some embodiments, the present invention may be provided as a computer program product or software which may include a machine or computer-readable medium having stored thereon instructions which may be used to program a computer (or other electronic devices) to perform a process according to the present invention. In other embodiments, processes of the present invention might be performed by specific hardware components that contain hardwired logic for performing the processes, or by any combination of programmed computer components and custom hardware components.

In an embodiment, the software used to facilitate the routine can be embedded onto a machine-readable medium. A machine-readable medium includes any mechanism that provides (i.e., stores and/or transmits) information in a form accessible by a machine (e.g., a computer, network device, personal digital assistant, manufacturing tool, any device with a set of one or more processors, etc.). For example, a machine-readable medium includes recordable/non-recordable media (e.g., read only memory (ROM) including firmware; random access memory (RAM); magnetic disk storage media; optical storage media; flash memory devices; etc.), as well as electrical, optical, acoustical or other form of propagated signals (e.g., carrier waves, infrared signals, digital signals, etc.); etc.

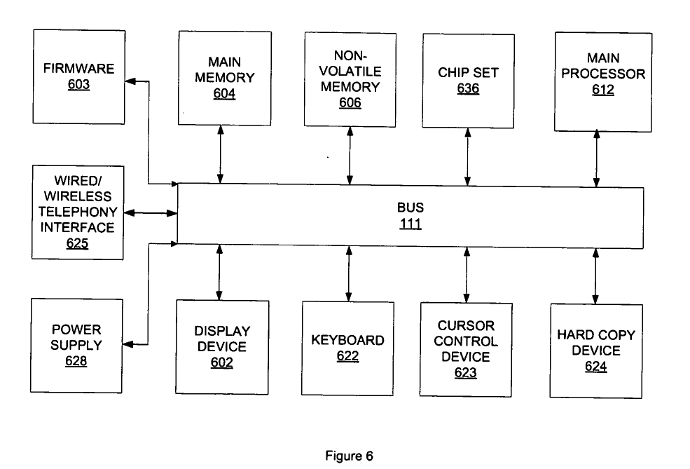

FIG. 6 illustrates a block diagram of an example method and apparatus for self-refresh in a display device being used in a mobile computer system. Firmware 603 may be a combination of software and hardware, such as Electronically Programmable Read-only Memory (EPROM) that has the operations for the routine recorded on the EPROM. The firmware 603 may embed foundation code, basic input/output system code (BIOS), or other similar code. The firmware 603 may make it possible for the computer system 600 to boot itself. Computer system 600 also comprises a read-only memory (ROM) and/or other static storage device 606 coupled to bus 611 for storing static information and instructions for main processing unit 612. The static storage device 606 may store OS level and application level software.

An alphanumeric input device (keyboard) 622, including alphanumeric and other keys, may also be coupled to bus 611 for communicating information and command selections to main processing unit 612. An additional user input device is cursor control device 623, such as a mouse, trackball, trackpad, stylus, or cursor direction keys, coupled to bus 611 for communicating direction information and command selections to main processing unit 612, and for controlling cursor movement on a display device 621. A chipset may interface with the input output devices. Another device that may be coupled to bus 611 is a hard copy device 624, which may be used for printing instructions, data, or other information on a medium such as paper, film, or similar types of media. Furthermore, a sound recording and playback device, such as a speaker and/or microphone (not shown) may optionally be coupled to bus 611 for audio interfacing with computer system 600. Another device that may be coupled to bus 611 is a wireless communication module 625. The wireless communication module 625 may employ a Wireless Application Protocol to establish a wireless communication channel. The wireless communication module 625 may implement a wireless networking standard such as Institute of Electrical and Electronics Engineers (IEEE) 802.11 standard, IEEE std. 802.11-1999, published by IEEE in 1999.

Computer system 600 may further be coupled to a display device 602, such as a cathode ray tube (CRT) or liquid crystal display (LCD), coupled to bus 611 for displaying information to a computer user. Chipset 636 may interface with the display device 621. In an embodiment, display device 602 is an LCD and chipset 636 may include graphic controller (not shown) to control the flow of image data between non-volatile memory 606 and display device 602. Display device 602 may also include a display controller (e.g. TCON, not shown) to control the drawing of pixels to the screen of display device 602.

Examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

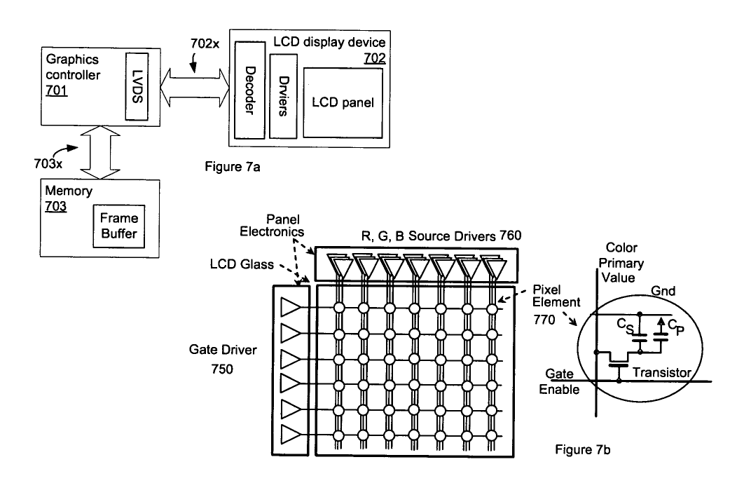

Embodiments of the invention are described in application to thin-film transistor (TFT) LCD panels. Referring to FIG. 7a, graphic controller 701 draws out pixels of a source image to the LCD display device 702 in serial lines. The process involves graphics controller 701 in the computer system reading the source image pixels from a frame buffer in memory 703 and passing the pixels serially to the display panel electronics via a display bus 702x, such as LVDS or TMDS. Referring to the TFT LCD panel of FIG. 7b, the pixel sub-color is created when a transistor in a pixel element 770 (embedded in film on the glass) near the pixel asserts an electric field charge between electrodes on the glass. The field causes crystals in solution in between the glass to align creating a circular polarization filter of variable angle. Prior to entering the liquid crystal, the panel light is polarized and hence the rotation of the pixel crystals creates variable impedance to the transmission of light. In an embodiment, there are three active transistor elements per pixel; one for each primary color: red, green and blue. There could however be fewer active transistors in monochromatic displays, and four active transistors in a RGBW (W=white) display.

To select a pixel, gate driver 750 may assert a logic level on a row-line to select the appropriate pixel row. This enables the transistor in the pixel element 770. The value of the pixel color is driven on the column-line by the source driver 760. This proceeds from left-right, top-to-bottom, painting the pixels row-by-row until the entire screen is painted. Once the pixel value has been asserted, to allow the pixel to hold its color there is a capacitor (Cs) connected to the transistor which stores the pixel value and continues to apply the charge to the pixel sub-color RGB electrodes (Cp) after the pixel element 770 is no longer driven by gate and source drivers 750, 760. As the pixels are charged the image forms on the panel.

Pixels may need to change color as objects within the frame-buffer of memory 703 are changed. Additionally, the capacitor Cs does not hold the color charge at the pixel forever. Hence, the image may be “refreshed” at a regular rate. In an embodiment, a selected refresh rate is a compromise between the minimal rate necessary to keep up with the change of pixels/images in the frame-buffer (without creating tearing, juddering or other visual artifacts), and the longest the pixels can hold their charge (without dimming or creating other artifacts such as flickering). In an embodiment, refresh rate is in the 30-60 Hz range. This refresh process repeatedly paints out the entire screen image even when the pixels and source image in the frame buffer in memory 703 have not changed.

The refresh process may consume a significant amount of power since it involves repeatedly reading the source image pixels from the frame buffer in memory 703 (e.g. line buffers in memory device must drive signal levels onto the memory bus lines), driving them over the display bus 702x (e.g. LVDS output buffer drivers must apply the signal onto the display bus line), and then being applied by the gate driver 750, source driver 770 and pixel sub-color transistors in pixel element 770.

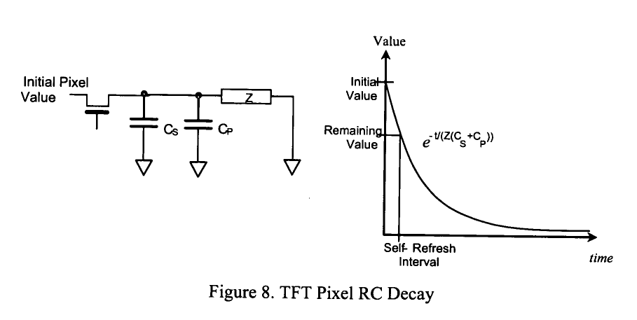

As explained above, to allow the pixel to hold its color once a pixel value has been asserted, there is a capacitor Cs connected to the transistor in pixel element 770 which stores the pixel value and continues to apply the charge to the pixel sub-color RGB electrodes Cp after the pixel element 770 is no longer driven by gate and source drivers 750, 760. FIG. 8 illustrates such a pixel value decaying from an initial value to a final value and shows the equation for the discharge rate of the pixel value as applied to the pixel sub-color circuit.

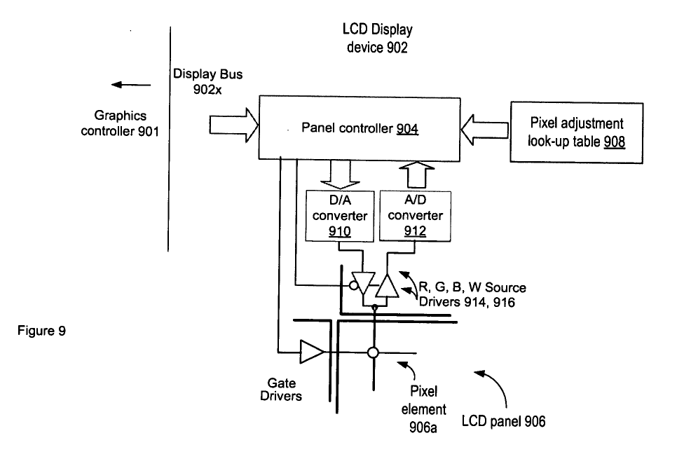

FIG. 9 is a block diagram illustrating embodiments of self-refresh in an LCD panel 906 controlled with panel controller 904. When a succession of frames contain pixels of identical value at each pixel position (e.g. the frame content is not changing over time), the panel controller 904 may be used to perform a self-refresh at a rate that may be less frequent and that dissipates less energy than the refresh rate provided by graphics controller 901. Self-refresh involves reading pixel values from the pixel element 906a transistor capacitor on the LCD panel 906, adjusting the pixel value that was read for the decay due to storage capacitor discharge, and then writing the adjusted pixel value back out to the LCD panel 906.

Graphics controller 901 may cause LCD display device 902 to enter into self-refresh mode when the detected EFPS indicates a lack of rendering or updating activity in the frame-buffer of memory. If activity (content changes) falls below a defined EFPS threshold, then self-refresh will be triggered by graphics controller 901. The self-refresh process can be triggered by an explicit signal from graphics controller 901 (using a special sequence within the existing display bus 902x (e.g. LVDS), or through a separate signal) indicating the LCD panel 906 should go into self-refresh mode. Graphics controller 901 may then remove its own display mode timings and memory refresh cycles.

In another embodiment, the panel controller 904 automatically enters into self-refresh mode when it does not detect a defined threshold number of refreshes from the graphics controller 901 within a time interval.

In an embodiment, graphics controller 901 may only partially update LCD panel 906 if the EFPS and the area of a frame required to be updated are below defined threshold levels.

In an embodiment, panel controller 904 uses the pixel element transistor capacitor Cs (e.g. FIGS. 7b, 8a) as a memory storage element which holds the pixel value for each primary color at each pixel position. After a pixel value is written to the sub-component storage of the pixel element 906a, the pixel value will degrade as it gradually discharges. In performing self-refresh, panel controller 904 may read the partially decayed pixel color values from each pixel element 906a. In an embodiment, partially decayed pixel values are read from pixel element 906a via A/D converter 912 and pixel source driver 916. In an embodiment, A/D converter 912 provides twice the data resolution that that of D/A converter 910 (resolution of one pixel) so that small changes in pixel value (e.g. fractions of pixel) can be detected and to avoid quantization errors.

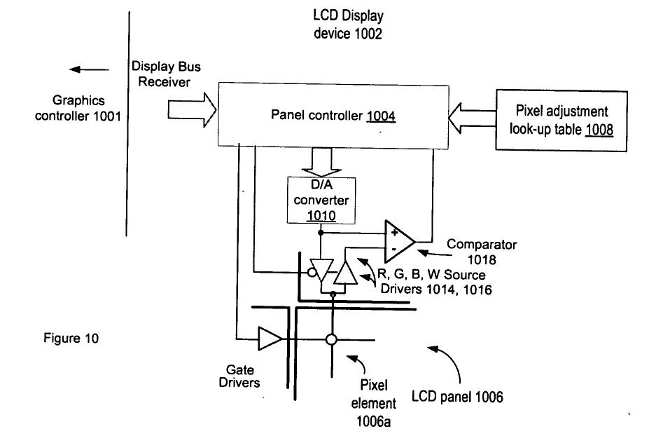

Referring briefly to FIG. 10, in an alternative embodiment, successive approximation is used to read partially decayed pixel values. Here, panel controller 1004 selects a pixel value at D/A converter 1010 and uses comparator 1018 to compare the pixel value to the partially decayed value read from pixel element 1006a and repeats the process until the pixel values are equal (e.g. using sequential or binary-tree search methods). As described above, the read resolution may be twice that of the pixel value in order to avoid quantization error, thus the D/A converter 1010 resolution is increased in the successive approximation embodiment.

With regard to the pixel value adjustment, if the partially decayed pixel value read from the pixel element 906 is thought of as a final value, then its initial value may be found at a given time based on the known decay rate of the storage capacitor (see e.g. FIG. 8). In an embodiment, the adjusted pixel values are stored in a pixel adjustment look-up table 908 implemented in a read only memory. Adjustment look-up table 908 contains adjusted pixel values that correspond to partially decayed pixel values when they are read from the pixel element 906a based on the time that has elapsed since the last refresh. In an embodiment, the table is preset with adjustment values based on one or more delay times that represent one or more intervals between self-refresh cycles. LCD display device 902 may exit self-refresh mode when graphics controller 901 resumes refreshing or as indicated by a display bus 902x interface signal.

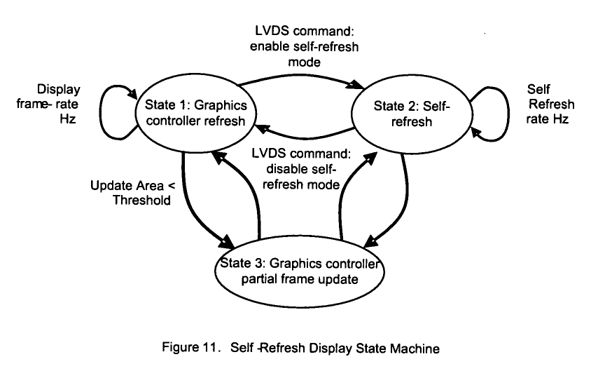

FIG. 11 illustrates an embodiment of a self-refresh panel state machine. Beginning with State 1, the panel (e.g. LCD panel 906 in FIG. 9) is refreshed by the graphics controller. While the display (e.g. LCD display device 902) is in States 1 and 2, the graphics controller will monitor the EFPS (e.g. with frame rate monitor 401a, FIG. 4) to detect the rate of content change to the panel. If the EFPS detected by the graphics controller falls below a defined threshold value, the graphics controller will transmit a signal to the display (e.g. with an LVDS semaphore) causing the display to enter State 2, the self refresh state.

When the display decodes the “enable self-refresh” signal from the graphics controller, it will enter into a mode in which the display controller (e.g. display controller 904) refreshes the panel. In another embodiment, the display enters into State 2 automatically when the display detects a number of graphic controller refreshes that is less than a defined threshold for a defined time interval. While in State 2, the display may refresh the panel at a refresh rate that is not greater than a refresh rate offered by the graphics controller.

While in State 2, the graphics controller continues to monitor the EFPS. If the graphics controller detects that the EFPS is no longer below the defined threshold value, the graphics controller will begin refreshing the panel again. When the display decodes the “disable self-refresh” signal (e.g. an LVDS semaphore), the display will enter back into State 1.

The display may enter into State 3 from States 1 or State 2. Graphics controller may also monitor the size of the area of a frame that is to be changed when a panel is updated with a new frame. If the EFPS and the area being updated are less than a defined threshold value, the graphics controller may cause the display to enter State 3, a partial update state. In a partial update state, the graphics controller writes only frame data that has changed from the last frame. In this way, rewriting the entire frame can be avoided when a relatively small portion of the pixel values cannot be retrieved from the display itself (when going from State 2 to State 3). When the conditions for State 3 are no longer satisfied, the display will enter back into its previous state.

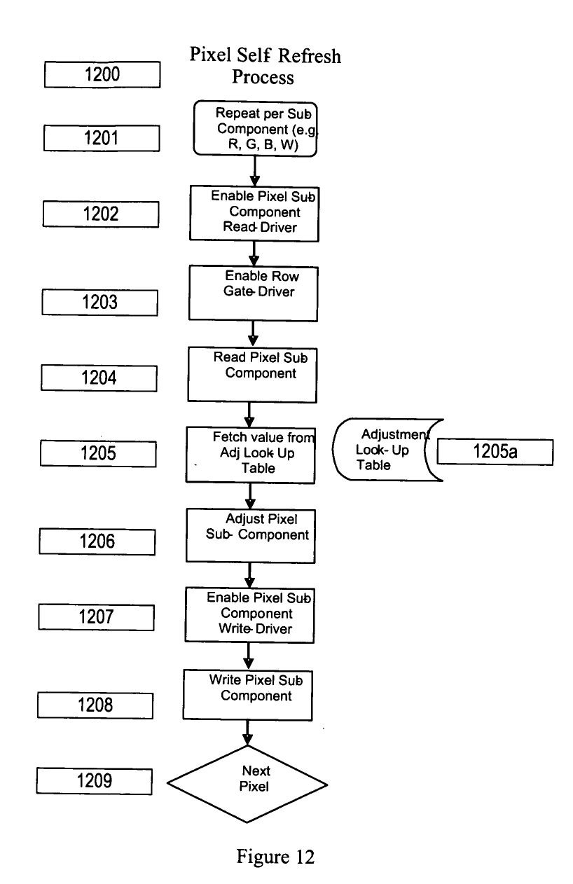

FIG. 12 is an algorithm of an embodiment for a pixel self-refresh process 1200. Beginning at block 1201, the logic of the algorithm should be followed for each of the pixel element subcomponents representing the colors red, green, blue and white. In block 1202, the pixel sub-component read driver is enabled and in block 1203, the row gate driver is enabled. At this point, in block 1204, the pixel sub-component is read. Once the pixel subcomponent value is ascertained, in block 1205 the corresponding adjusted value is fetched from the look up table in block 1205a. With the updated value, the pixel sub-component value is adjusted in block 1206. Finally the write component is enabled in block 1207 and the value is written in block 1208. As described above, the process is repeated by block 1209 for each sub-component.

Through the practice of embodiments described herein, reduced power consumption by a computer system including display device may be realized by using a self-refresh rate that temporarily reduces power consumption involved with refresh operations performed by a graphics control module. Other applications may be able to leverage the ability of components of the pixel element to store pixel values coupled with the accessibility of those values to improve visual quality in a display (e.g. using the old state of a pixel and temporal compensation to account for pixel latency). Additionally, moving the refresh operation to the display device itself may free up resources previously responsible for refresh, leading to improved graphical or non-graphical performance.

Some portions of the detailed descriptions have been presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is appreciated that throughout the present invention, discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

Thus, a method and apparatus for self-refresh in a display device has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. An apparatus, comprising:
a system display having a display screen that includes a pixel value storage component, the system display to be coupled with a graphics control module via a display bus and to enable a self-refresh mode based on a first indication from the graphics control module, the self-refresh mode to include refreshing pixel values stored within the pixel value storage component, and wherein a self-refresh rate is not greater than a first refresh rate provided by the graphics control module.

2. The apparatus of claim 1, wherein the system display further comprises:
a display control module configured to refresh pixel values read from within the pixel value storage and to write the refreshed pixel values back into the pixel value storage.

3. The apparatus of claim 1, wherein the system display includes a refresh module to receive the first indication from the graphics control module and to trigger the self-refresh mode based on the first indication, and to receive a second indication from the graphic control module that triggers the self-refresh mode to be disabled based on the second indication.

4. The apparatus of claim 2, wherein the system display further comprises:
a refresh value module coupled with the display control module, the refresh value module to store new pixel values that correspond to old pixel values read from within the pixel value storage, wherein the display control module to refresh the old pixel values by exchanging them with corresponding new pixel values retrieved from the refresh value module.

5. The apparatus of claim 4, wherein the system display is a thin film transistor liquid crystal diode (LCD) display, the display control module is a timing controller (TCON), the TCON implementing an algorithm to read a decayed sub-pixel value from each pixel element sub-pixel capacitor via an analog to digital converter, and the refresh value module is a lookup table implemented in a memory to store for each sub-pixel capacitor an initial pixel value that corresponds to the read decayed pixel value at a time that has elapsed since the sub-pixel capacitor was last refreshed.

6. A method, comprising:
operating in a first refresh mode that is controlled external to a system display;
entering a second refresh mode that is controlled from within the system display in response to a signal received at the system display;
operating in the second refresh mode, wherein the second refresh mode is a self-refresh mode and that provides a refresh rate that is not greater than a rate of the first refresh mode.

7. The method of claim 6, wherein operating in the second refresh mode includes reading a first pixel value from a pixel value storage located on the system display, refreshing the first value, and writing the refreshed first value back to the pixel value storage.

8. The method of claim 7, wherein refreshing the first pixel value includes retrieving a second pixel value from a refresh value module, wherein selection of the second pixel value depends on a difference between a first time the first pixel value was last refreshed and a second time it was retrieved; and refreshing the first pixel value by replacing the first pixel value with the second pixel value.

9. An apparatus, comprising:
a graphics control module having a first output terminal to couple with a memory via a memory bus and a second output terminal to couple to a display device via a display bus and configured to control refresh of the display device, and including a frame rate monitor to track an effective frame rate of the display device and to cause the graphics control module to stop controlling the refresh when a threshold effective frame rate value has been detected, and including a self-refresh signaler to transmit one or more signals to the display device upon detection of the threshold effective frame rate value to trigger the display device to enter a self-refresh mode.

10. The apparatus of claim 9, wherein the graphics control module is a graphics controller embedded within a graphics memory controller hub (GMCH), and transmits refresh frames to the system display over the display bus using low voltage differential signaling (LVDS), and the self-refresh signaler encodes and transmits the one or more signals over the display bus using LVDS.

11. The apparatus of claim 10, wherein the frame rate monitor tracks the frame rate by determining the effective frame rate per second from at least one of rendering activity and updating activity in a frame buffer within the memory, and the threshold frame rate is an effective frame per second threshold.

12. A method comprising:
refreshing a display device;
tracking an effective frame rate related to the display device; and
discontinuing refresh of the display device and issuing a signal to the display device to cause the display to enter a self-refresh mode if a minimum effective frame rate is detected.

13. The method of claim 12, further comprising:
resuming refresh of the display device and issuing a signal to the display to exit the self-refresh mode if the effective frame rate exceeding the minimum effective frame rate is detected.

14. The method of claim 13, wherein the signal to the display device is encoded into a low voltage differential signal.

15. The method of claim 13, wherein the effective frame rate is an effective frame rate per second measured by update and rendering activity in a memory that stores frames for the display.

16. A system, comprising
a mobile computing system including a direct current power source;
a system display coupled with a graphics control module that controls a refresh rate of the system display via a display bus, the system display having a display screen that includes a pixel value storage component, the system display to enable a self-refresh mode based on a first indication from the graphics control module, the self-refresh mode to include refreshing pixel values stored within the pixel value storage component, and wherein a self-refresh rate is not greater than a first refresh rate provided by the graphics control module.

17. The system of claim 16, wherein the system display further comprises:
a display control module configured to refresh pixel values read from within the pixel value storage and to write the refreshed pixel values back into the pixel value storage.

18. The apparatus of claim 16, wherein the system display further comprises:
a refresh value module coupled with the display control module, the refresh value module to store new pixel values that correspond to old pixel values read from within the pixel value storage, wherein the display control module to refresh the old pixel values by exchanging them with corresponding new pixel values retrieved from the refresh value module.

19. The system of claim 16, wherein the graphics control module further comprises:
a frame rate monitor to track an effective frame rate of the display device and to cause the graphics control module to stop controlling the refresh when a threshold effective frame rate value has been detected, and including a self-refresh signaler to transmit one or more signals to the display device upon detection of the threshold effective frame rate value to trigger the display device to enter a self-refresh mode.

20. The system of claim 19, wherein the frame rate monitor tracks the frame rate by determining the effective frame rate per second from at least one of rendering activity and updating activity in a frame buffer within the memory, and the threshold frame rate is an effective frame per second threshold.
